(19) United States
(12) Patent Application Publication
(10) Pub. No.: US 2020/0060061 A1
(43) Pub. Date: Feb. 27, 2020

(54) SYSTEMS AND METHODS FOR CONTROLLING THE POSITION OF ROW UNITS OF AN AGRICULTURAL IMPLEMENT

(71) Applicant: CNH Industrial America LLC, New Holland, PA (US)

(72) Inventor: Adam L. Hession, Davenport, IA (US)

(73) Assignee: CNH Industrial America LLC

(21) Appl. No.: 16/108,900

(22) Filed: Aug. 22, 2018

(51) Int. Cl. A01B 63/00; A01B 63/32; A01C 5/06

(52) U.S. Cl. CPC A01B 63/008; A01C 5/068; A01C 5/064; A01B 63/32

(57) ABSTRACT

In one aspect, a system for controlling the position of row units of an agricultural implement as the implement is moved across a field may include a row unit. The system may also include an actuator configured to adjust a position of the row unit between an operating position relative to the ground and a raised position relative to the ground. Additionally, the system may also include a controller configured to monitor a current location of the row unit relative to a boundary defined between a processed portion of the field and an unprocessed portion of the field. Furthermore, the controller may be configured to control an operation of the actuator to initiate adjustment the position of the row unit between the operating and raised positions when it is determined that the row unit is about to traverse across the boundary.

### FIELD

The present disclosure generally relates to agricultural implements and, more particularly, to systems and methods for controlling the position of row units of an agricultural implement as the implement is moved across a field.

### BACKGROUND

Modern farming practices strive to increase yields of agricultural fields. In this respect, seed planting implements are towed behind a tractor or other work vehicle to deposit seeds in a field. For example, seed planting implements typically include one or more furrow forming tools or openers that form a furrow or trench in the soil. One or more dispensing devices of the seed planting implement may, in turn, deposit seeds into the furrow(s). After deposition of the seeds, a press wheel may pack the soil on top of the deposited seeds.

To maximize efficiency, it is desirable that the seed planting implement traverse each portion of the field in a single pass. As such, farmers generally tow seed planting implements across the field along a series of parallel swaths or rows. However, when the field has an irregular shape (e.g., a triangular shape), it may be necessary for the seed planting implement to traverse a portion of the field that has already been planted. In such instances, the opener(s) may move or damage the previously planted seeds.

Accordingly, an improved system and method for controlling the position of a row unit of an agricultural implement to prevent overlapping planting passes within a field would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for controlling the position of row units of an agricultural implement as the implement is moved across a field. The system may include a row unit and an actuator configured to adjust a position of the row unit between an operating position relative to the ground and a raised position relative to the ground. The system may also include a controller configured to monitor a current location of the row unit relative to a boundary defined between a processed portion of the field and an unprocessed portion of the field. Furthermore, the controller may be configured to control an operation of the actuator to initiate adjustment the position of the row unit between the operating and raised positions when it is determined that the row unit is about to traverse across the boundary.

In another aspect, the present subject matter is directed to an agricultural implement that may include a toolbar and a first row unit adjustably mounted on the toolbar, with the first row unit including a first furrow forming device. The implement may also include a first actuator configured to adjust a position of the first row unit relative to the toolbar to move the first row unit between an operating position relative to the ground and a raised position relative to the ground. The implement may further include a second row unit adjustably mounted on the toolbar, with the second row unit including a second furrow forming device. Moreover, the implement may include a second actuator configured to adjust a position of the second row unit relative to the toolbar to move the second row unit between the operating and raised positions. Additionally, the implement may include a controller configured to monitor current locations of the first and second row units relative to a boundary defined between a processed portion of a field and an unprocessed portion of the field. Furthermore, the controller may be configured to independently control the operation of the first and second actuators such that adjustment of the first row unit between the operating and raised positions is initiated when it is determined that the first row unit is about to traverse across the boundary and adjustment of the second row unit device between the operating and raised positions is initiated when it is determined that the second row unit is about to traverse across the boundary.

In a further aspect, the present subject matter is directed to a method for controlling the position of row units of an agricultural implement. The implement may include an actuator configured to adjust the row unit between an operating position relative to the ground and a raised position relative to the ground. The method may include operating, with a computing device, the implement such that the implement is moved across a field. The method may also include monitoring, with the computing device, a current location of the row unit relative to a boundary defined between a processed portion of the field and an unprocessed portion of the field. Furthermore, when the row unit is about to traverse across the boundary, the method may include controlling, with the computing device, an operation of the actuator to initiate adjustment the position of the row unit between the operating and raised positions.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle, an air cart, and a seed planting implement in accordance with aspects of the present subject matter;

FIG. 2 illustrates an enlarged, partial perspective view of one embodiment of the seed planting implement shown in FIG. 1, particularly illustrating an actuator configured to collectively adjust the positions of a plurality of row units of the implement in accordance with aspects of the present subject matter;

FIG. 3 an enlarged, partial side view of another embodiment of the seed planting implement shown in FIG. 1, particularly illustrating an actuator configured to adjust the position of an individual row unit of a plurality of row units of the implement in accordance with aspects of the present subject matter;

FIG. 4 illustrates a schematic view of one embodiment of a system for controlling the position of row units of an agricultural implement in accordance with aspects of the present subject matter;

FIG. 5 illustrates an example map of a portion of a field having a processed portion and an unprocessed portion separated by a boundary in accordance with aspects of the present subject matter, particularly illustrating a first row unit of the implement positioned within the processed portion and a second row unit of the implement positioned within the unprocessed portion; and

FIG. 6 illustrates a flow diagram of one embodiment of a system for controlling the position of row units of an agricultural implement in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the position of row units of an agricultural implement. Specifically, in several embodiments, as the implement is moved across a field, a controller of the disclosed system may be configured to monitor the current location of each row unit relative to a boundary defined between a processed portion of the field and an unprocessed portion of the field. For example, in one embodiment, the processed portion of the field may correspond to an area of the field in which seeds have already been planted, while the unprocessed portion of the field may correspond to an unplanted area of the field. When a given row unit is about to traverse across the boundary into the processed portion of the field, the controller may be configured to control the operation of an actuator of the implement to move the row unit from an operating position relative to the ground to a raised position relative to the ground. When the row unit is at raised position, a furrow forming tool(s), such as a disc or hoe opener(s), of the row unit is lifted out of the soil. As such, the implement may traverse the processed portion of the field without moving, damaging, or otherwise disturbing the already planted seeds. Thereafter, when the row unit is about to traverse across the boundary into back the unprocessed portion of the field, the controller may be configured to control the operation of the actuator to move the row unit from the raised position to the operating position to continue processing (e.g., planting) the field.

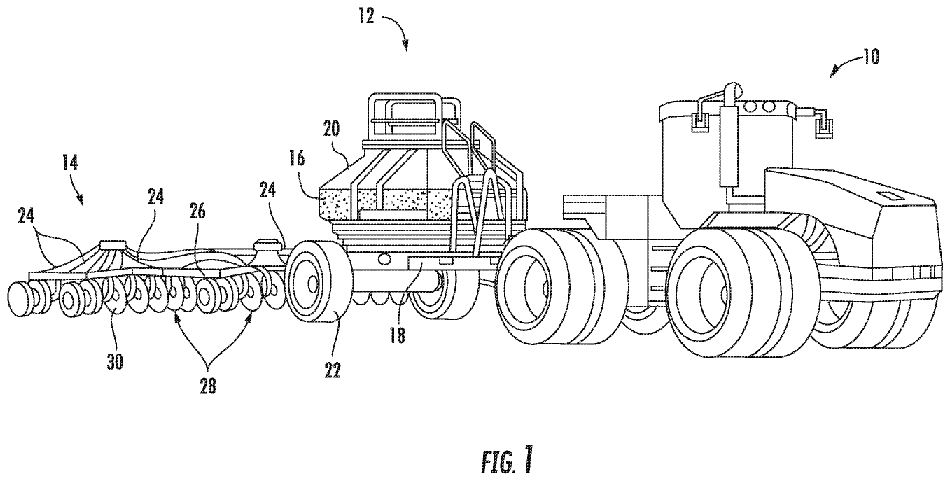

Referring now to drawings, FIG. 1 illustrates a perspective view of one embodiment of a work vehicle 10, an air cart 12, and a seed planting implement 14 in accordance with aspects of the present subject matter. It should be appreciated that, although the work vehicle 10 illustrated herein is configured as a tractor, the work vehicle 10 may generally be configured as any suitable work vehicle known in the art, such as any other agricultural vehicle. It should also be appreciated that, although the seed planting implement 14 illustrated herein corresponds to a seed disc drill, the implement 14 may generally correspond to any suitable equipment or implement, such as seed hoe drill or another seed dispensing implement, a side dresser or another a fertilizer dispensing implement, a strip tiller, and/or the like.

As shown, the air cart 12 may be configured to be towed directly behind the work vehicle 10, with the seed planting implement 14 being towed behind the air cart 12. In this regard, a hitch assembly (not shown) may be configured to couple the air cart 12 to the work vehicle 10. Furthermore, another hitch assembly (not shown) may be configured to couple the seed planting implement 14 to the air cart 12. However, in an alternative embodiment, the seed planting implement 14 may be towed directly behind the work vehicle 10, with the air cart 12 being towed behind the seed planting implement 14. In a further embodiment, the air cart 12 and the seed planting implement 14 may be part of a single unit that is towed behind the work vehicle 10, or elements of a self-propelled vehicle configured to distribute agricultural product across a field.

In accordance with aspects of the present disclosure, the air cart 12 may be configured to store a flowable liquid or granular agricultural product 16, such as seeds, fertilizer, and/or the like, to be deposited within the soil. Specifically, in several embodiments, the air cart 12 may include a frame 18 configured to support or couple to various components of the air cart 12. For example, as shown, the frame 18 may be configured to support a hopper or storage tank 20 configured for storing the agricultural product 16 to be deposited within the furrow. Furthermore, in one embodiment, a plurality of wheels 22 may be coupled to the frame 18 to permit the air cart 12 to be towed across a field by the work vehicle 10. Additionally, a plurality of delivery conduits 24 may be configured to convey the agricultural product 16 from the air cart 12 to the seed planting implement 14 for deposition into the furrow.

In several embodiments, the seed planting implement 14 may include a toolbar 26 configured to support or couple to various components of the implement 14, such as one or more row units 28. As will be described below, each row unit 28 may include one or more furrow forming tools, such as the illustrated disc openers 30, configured to excavate a furrow or trench in soil to facilitate deposition of a flowable granular or particulate-type agricultural product 16. It should be appreciated that the seed planting implement 14 may generally include any number of row units 28 to facilitate delivery of the agricultural product 16 across a given swath of the soil. For instance, in one embodiment, the implement 14 may include twenty-four row units 28 spaced apart across the width of the seed planting implement 14. In alternative embodiments, however, the seed planting implement 14 may include any other suitable number of row units 28, such as less than twenty-four row units 28 or more than twenty-four row units 28. Moreover, it should be appreciated that, in alternative embodiments, the furrow forming tool(s) may be configured as a hoe(s), a coulter(s), or any suitable tool(s).

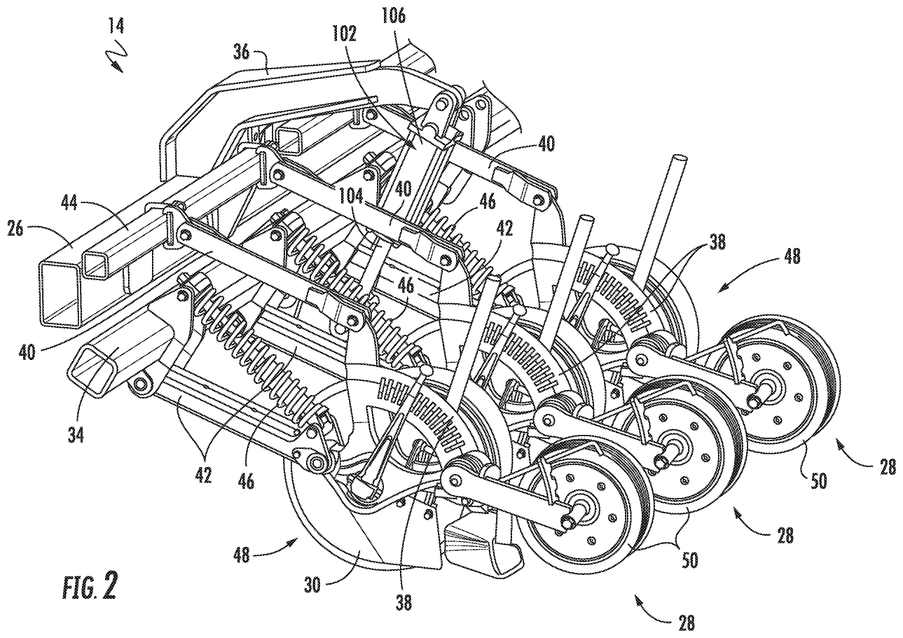

Referring now to FIG. 2, an enlarged, partial perspective view of one embodiment of the seed planting implement 14 shown in FIG. 1 is illustrated in accordance with aspects of the present subject matter. As shown, the seed planting implement 14 may include a rockshaft 34 that is moveable relative to the toolbar 26. In this regard, the seed planting implement 14 may include an actuator 102 (e.g., a rockshaft cylinder) configured to rotate or otherwise move the rockshaft 34 relative to the toolbar 26. For example, as shown in the illustrated embodiment, a first end of the actuator 102 (e.g., a rod 104 of the actuator 102) may be coupled to the rockshaft 34, while a second end of the actuator 102 (e.g., a cylinder 106 of the actuator 102) may be coupled to a support arm 36 of the seed planting implement 14, which is, in turn, mounted to the toolbar 26. The rod 104 of the actuator 102 may be configured to extend and/or retract relative to the cylinder 106 of the actuator 102 to rotate the rockshaft 34 relative to the toolbar 26, which, in turn, adjusts the position of the various row units 28 ganged together via the rockshaft 34. For example, rotation of the rockshaft 34 may move the row units 28 between an operating position relative to the ground in which the corresponding disc opener(s) 30 engages the soil and a raised position relative to the ground in which the corresponding disc opener(s) is lifted out of the soil. In the illustrated embodiment, the actuator 102 corresponds to a fluid-driven actuator, such as a hydraulic or pneumatic cylinder. However, it should be appreciated that the actuator 102 may correspond to any other suitable type of actuator, such as an electric linear actuator.

In several embodiments, a plurality of the row units 28 of the seed planting implement 14 may be ganged together via the toolbar 26 and associated rockshaft 34, with each row unit 28 including a frame member or backbone 38 adjustably coupled to the toolbar 26 and the rockshaft 34 by upper and lower links 40, 42. For example, one end of each upper link 40 may be pivotably coupled to the corresponding frame member 38 of the row unit 28, while an opposed end of each upper link 40 may be pivotably coupled to a rail 44 of the seed planting implement 14, which is, in turn, mounted to the toolbar 26. Similarly, one end of each lower link 42 may be pivotably coupled to the corresponding frame member 42, while an opposed end of each lower link 42 may be pivotably coupled to the rockshaft 34. In one embodiment, the upper and lower links 40, 42 may be parallel. Furthermore, in one embodiment, each lower link 42 may include a biasing member 46, such as the illustrated spring, coupled between the corresponding frame member 38 and the rockshaft 34 to apply a down force or pressure through the frame member 38 and the various components coupled thereto. However, it should be appreciated that, in alternative embodiments, each row unit 28 may be coupled to the toolbar 26 and/or the rockshaft 34 in any other suitable manner. For example, the upper and/or lower links 40, 42 may be fixedly coupled to the frame member 38 and/or the links 40, 42 may be non-parallel. Additionally, in a further embodiment, the seed planting implement 14 may not include the upper and/or lower links 40, 42. In such instance, the seed planting implement 14 may include other components for coupling each row unit 28 to the toolbar 26 and/or the rockshaft 34.

As shown in FIG. 2, each row unit 28 may also include a furrow opening assembly 48, a furrow closing assembly (not shown), and a press wheel 50. In general, each furrow opening assembly 48 may include one or more furrow forming tools, such as the disc opener(s) 30, which are configured to excavate a furrow or trench in the soil for the deposition of seeds or other agricultural substances therein (e.g., fertilizer). The furrow closing assemblies are not shown to better illustrate the disc openers 30. As is generally understood, each furrow closing assembly may include a closing disc(s) configured to close the furrow after seeds have been deposited into the furrow. Each press wheel 50 may then be configured to roll over the corresponding closed furrow to firm the soil over the seeds and promote favorable seed-to-soil contact.

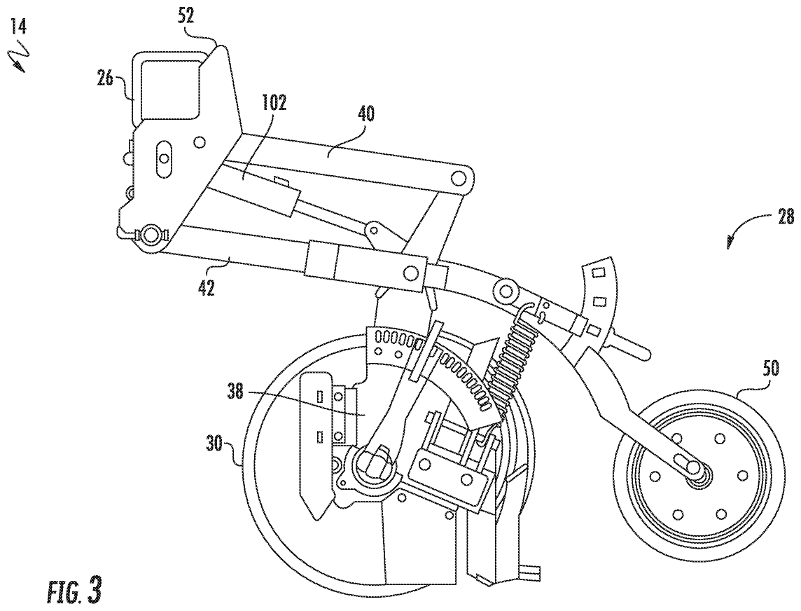

Referring now to FIG. 3, an enlarged, partial side view of another embodiment of the seed planting implement 14 shown in FIG. 1 is illustrated in accordance with aspects of the present subject matter. As shown, the implement 14 may generally be configured the same as or similar to that described above with reference to FIG. 2. For instance, the implement 14 may include the plurality of row units 28 (only one row unit 28 is shown in FIG. 3), with each row unit 28 including a furrow opening assembly 48, a furrow closing assembly, and a press wheel 50. However, as shown in FIG. 3, unlike the above-described embodiment, the row units 28 may be independently adjustably coupled to the toolbar 26 by the upper and lower links 40, 42. For example, one end of each upper and lower link 40, 42 may be pivotably coupled to the frame member 38 of the corresponding row unit 28, while an opposed end of each upper and lower link 40, 42 may be pivotably coupled to a bracket 52, which is, in turn, coupled to the toolbar 26. However, it should be appreciated that, in alternative embodiments, each row unit 28 may be coupled to the toolbar 26 in any other suitable manner. Additionally, in further embodiment, the seed planting implement 14 may not include the upper and/or lower links 40, 42. Instead, the seed planting implement 14 may include other components for coupling each row unit 28 to the toolbar 26.

Additionally, in several embodiments, the seed planting implement 14 may include a plurality of actuators 102 (only one is shown in FIG. 3), with each actuator 102 being configured to move or otherwise adjust the position of the corresponding row unit 28 relative to the toolbar 26. For example, as shown in the illustrated embodiment, a first end of each actuator 102 (e.g., the rod 104 of the corresponding actuator 102) may be coupled to the frame member 38 of the corresponding row unit 28, while a second end of each actuator 102 (e.g., the cylinder 106 of the corresponding actuator 102) may be coupled to the toolbar 26. The rod 104 of each actuator 102 may be configured to extend and/or retract relative to the corresponding cylinder 106 to adjust the position of the corresponding row unit 28, such as between the operating and raised positions. In the illustrated embodiment, the actuators 102 correspond to fluid-driven actuators, such as hydraulic or pneumatic cylinders. However, it should be appreciated that the actuators 102 may correspond to any other suitable type of actuators, such as electric linear actuators.

It should also be appreciated that the configuration of the seed planting implement 14 described above and shown in FIGS. 1-3 is provided only to place the present subject matter in an exemplary field of use. Thus, it should be appreciated that the present subject matter may be readily adaptable to any manner of seeder configuration.

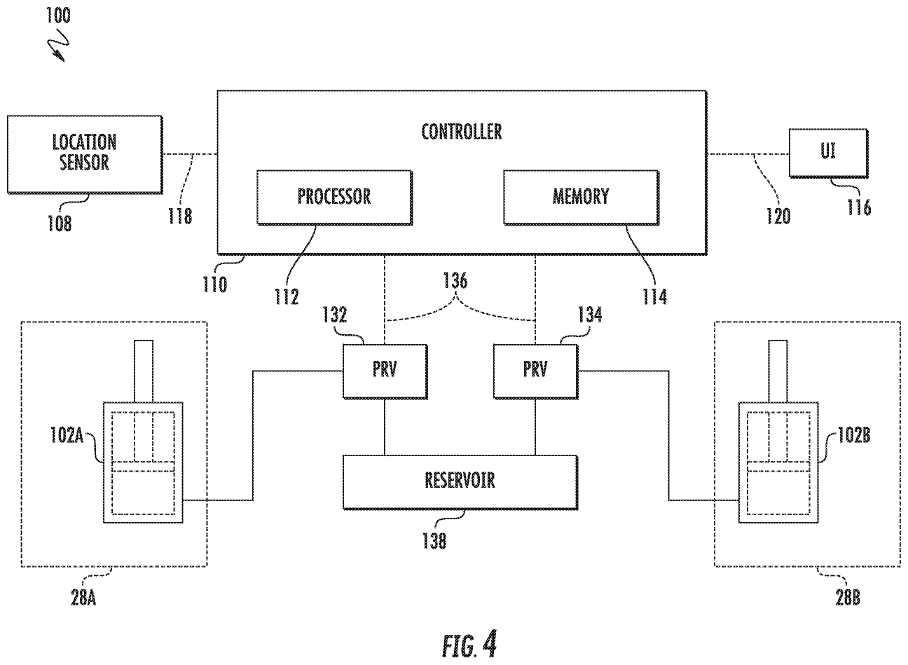

Referring now to FIG. 4, a schematic view of one embodiment of a system 100 for controlling the position of row units of an agricultural implement is illustrated in accordance with aspects of the present subject matter. In general, the system 100 will be described herein with reference to the seed planting implement 14 described above with reference to FIGS. 1-3. However, it should be appreciated by those of ordinary skill in the art that the disclosed system 100 may generally be utilized with implements having any other suitable implement configuration.

As shown in FIG. 4, the system 100 may include one or more components of the seed planting implement 14 described above with reference to FIGS. 1-3. Specifically, in the embodiment illustrated in FIG. 4, the system 100 may include a first actuator 102A configured to adjust the position of a first row unit 28A of the implement 14 between the operating and raised positions and a second actuator 102B configured to adjust the position of a second row unit 28B of the implement 14 between the operating and raised positions. However, it should be appreciated that, in alternative embodiments, the system 100 may include any other suitable number of actuators 102 and/or each actuator 102 may be configured to adjust the position of any other suitable number of row units 28. For example, in one embodiment, the system 100 may include one actuator 102 configured to collectively adjust the positions of the first and second row units 28A, 28B (e.g., via the rockshaft 34) between the raised and lowered positions.

In several embodiments, the system 100 may include a location sensor 108 configured to detect a parameter associated with a geographical or physical location of the seed planting implement 14 within the field. For instance, in one embodiment, the location sensor 104 may correspond to a GNSS-based receiver configured to detect the GNSS coordinates of the work vehicle 10, the air cart 12, and/or the seed planting implement 14. As such, the location sensor 104 may mounted on the work vehicle 10, the air cart 12, and/or the seed planting implement 14. However, it should be appreciated that, in alternative embodiments, the location sensor 108 may be configured as any suitable location sensing device for detecting the location of the work vehicle 10, the air cart 12, and/or the seed planting implement 14.

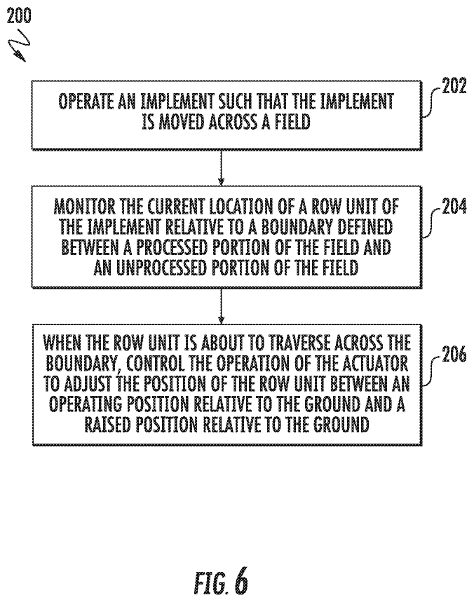

In accordance with aspects of the present subject matter, the system 100 may further include a controller 110 configured to electronically control the operation of one or more components of the seed planting implement 14. In general, the controller 110 may comprise any suitable processor-based device known in the art, such as a computing device or any suitable combination of computing devices. Thus, in several embodiments, the controller 110 may include one or more processor(s) 112 and associated memory device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 114 of the controller 110 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 114 may generally be configured to store suitable computer-readable instructions that, when implemented by the processor(s) 112, configure the controller 110 to perform various computer-implemented functions, such as one or more aspects of the method 200 described below with reference to FIG. 6. In addition, the controller 110 may also include various other suitable components, such as a communications circuit or module, one or more input/output channels, a data/control bus and/or the like.

It should be appreciated that the controller 110 may correspond to an existing controller of the work vehicle 10, the air cart 12, or the seed planting implement 14 or the controller 110 may correspond to a separate processing device. For instance, in one embodiment, the controller 110 may form all or part of a separate plug-in module that may be installed within the work vehicle 10, the air cart 12, or the seed planting implement 14 to allow for the disclosed system and method to be implemented without requiring additional software to be uploaded onto existing control devices of the work vehicle 10, the air cart 12, or the seed planting implement 14.

Furthermore, in one embodiment, the system 100 may also include a user interface 116 that is configured to receive an input from an operator of the seed planting implement 14, such as an input associated with the location of the first and/or second row units 28 within the field. As such, the user interface 116 may include one or more input devices (not shown), such as touchscreens, keypads, touchpads, knobs, buttons, sliders, switches, mice, microphones, and/or the like, which are configured to receive user inputs from the operator. In addition, some embodiments of the user interface 116 may include one or more feedback devices (not shown), such as display screens, speakers, warning lights, and/or the like, which are configured to communicate the feedback, such as feedback from the controller 110, to the operator of the seed planting implement 14. However, in alternative embodiments, the user interface 116 may have any suitable configuration.

In several embodiments, the controller 110 may be configured to monitor the current locations of one or more row units 28 of the implement 10, such as the first and second row units 28A, 28B, relative to one or more boundaries defined between a processed portion(s) of the field and an unprocessed portion(s) of the field. In general, the processed portion(s) of the field may correspond to a region the field in which an agricultural operation (e.g., planting, fertilizing, and/or the like) has already been performed. Conversely, the unprocessed portion(s) of the field may correspond to a region of the field in which the agricultural operation has not yet been performed. As such, the agricultural substance (e.g., seed, fertilizer, and/or the like) may be present within the processed portion of the field, but not within the unprocessed portion of the field. More specifically, in one embodiment, as the seed planting implement 14 is moved across the field, the controller 110 may be configured to determine the current locations of the first and second row units 28A, 28B based on one or more received inputs. Thereafter, the controller 110 may compare the determined locations of the first and second row units 28A, 28B relative to the location(s) of the boundary(ies). As will be described below, in the event that one or more row units 28 of the implement 10, such as the first and/or second row units 28A, 28B, are about to traverse across one of the boundaries, the controller 110 may be configured to control the operation of one or more components of the seed planting implement 14 in a manner that initiates adjustment of the position(s) of such row unit(s) between the operating and raised positions.

In one embodiment, the controller 110 may be configured to determine the current locations of one or more row units 28 on data received from the location sensor 108. Specifically, in one embodiment, the controller 110 may be communicatively coupled to the location sensor 108 via a wired or wireless connection to allow location data (e.g., indicated by dashed line 118 in FIG. 4) to be transmitted from the location sensor 108 to the controller 110. The controller 110 may then be configured to determine or estimate the location of the first and/or second row units 28A, 28B based on the location data 118 received from the location sensor 108. For instance, the controller 110 may include a lookup-up table, suitable mathematical formula, and/or algorithms stored within its memory 114 that correlates the location data 118 to the locations of the first and/or second row units 28A, 28B.

As indicated above, the location sensor 104 may be a single sensor mounted on the work vehicle 10, the air cart 12, or the seed planting implement 14. In this regard, the raw location data 118 may provide an indication of the current location of the location sensor 104 and not of the first and second row units 28A, 28B. As such, the controller 110 may be configured to apply a plurality of adjustment or correction factors to the location provided by the location sensor 104, with each adjustment factor being indicative of the distance defined between the location sensor 104 and one of the first or second row units 28A, 28B. For example, the controller 110 may be configured to apply a first adjustment factor to the location provided by the location sensor 104 to determine the location of the first row unit 28A and a second adjustment factor to the location provided by the location sensor 104 to determine the location of the second row unit 28B. It should be appreciated that the first and second adjustment factors may be different as the locations of the first and second row units 28A, 28B are also different.

Furthermore, in one embodiment, the controller 110 may be configured to determine the current locations of one or more row units 28 based on operator input received from the user interface 116. Specifically, in one embodiment, the controller 110 may be communicatively coupled to the user interface 116 via a wired or wireless connection to allow user input signals (e.g., indicated by dashed line 120 in FIG. 4) to be transmitted from the user interface 116 to the controller 110. In general, the user input signals 120 may be notifications from the operator of the seed planting implement 14 that the first and/or second row units 28A, 28B are about to traverse across one of the boundaries defined between the processed and unprocessed portions of the field. However, it should be appreciated that, in alternative embodiments, the controller 110 may be configured to receive any other suitable input indicating that the first and/or second row units 28A, 28B are about to traverse across the boundaries.

Additionally, in one embodiment, the controller 110 may be configured to store the location(s) of the boundary(ies) between the processed and unprocessed portions of the field within its memory 114. However, it should be appreciated that the location(s) of the boundary(ies) may change as the seed planting implement 14 is towed across the field. That is, as the seed planting implement 14 deposits seeds or other agricultural products within a previously unprocessed portion(s) of the field, the size of the processed portion(s) of the field will increase, while the size of the unprocessed portion(s) of the field will decrease, thereby changing the location of the boundary(ies) therebetween. As such, the controller 110 may be configured to update the location(s) of the boundary(ies) stored within its memory 114 continuously or at a predetermined rate or interval as the seed planting implement 14 is moved across the field.

As indicated above, upon determining that one or more row units 28 are about to traverse across one of the boundaries defined between the processed and unprocessed portions of the field, the controller 110 may be configured to control the operation of the associated actuator(s) 102 of the seed planting implement 14 in a manner that initiates adjustment of the positions of such row unit(s) 28 between the operating and raised positions. Specifically, in several embodiments, when the first and/or second row units 28A, 28B are about to traverse across one of the boundaries from an unprocessed portion of the field into a processed portion of the field, the controller 110 may be configured to control the operation of the first and/or second actuators 102A, 102B such that the positions of first and/or second row units 28A, 28B are adjusted from the operating position to the raised position. As such, the disc opener(s) 30 mounted on the first and/or second row units 28A, 28B may be lifted out of the ground when the first and/or second row units 28A, 28B travel across the processed portion of the field, thereby preventing movement of or damage to the previously deposited agricultural substance. Moreover, when the first and/or second row units 28A, 28B are about to traverse across one of the boundaries from a processed portion of the field into an unprocessed portion of the field, the controller 110 may be configured to control the operation of the first and/or second actuators 102A, 102B such that the positions of first and/or second row units 28A, 28B are adjusted from the raised position to the operating position. In this regard, the disc opener(s) 30 mounted on the first and/or second row units 28A, 28B may engage the soil to facilitate formation of the furrow(s) when the first and/or second row units 28A, 28B travel across the unprocessed portions of the field.

It should be appreciated that, in one embodiment, the row unit(s) 28 may be about to traverse across one of the boundaries when such row unit(s) 28 are within five feet of the boundary, such as within four feet of the boundary, within three feet of the boundary, within two feet of the boundary, within one foot of the boundary, within six inches of the boundary, and/or on the boundary. In a further embodiment, the row unit(s) 28 may be about to traverse across one of the boundaries when such row unit(s) 28 will be positioned over the boundary within three seconds of continued travel of the row unit(s) 28, such as within two seconds, within one second, within half of a second, and/or zero seconds.

In several embodiments, the positions of the row unit(s) 28 may be adjusted between the operating and raised positions as a collective unit. Specifically, in one embodiment, when one of the first or second row units 28A, 28B is about to traverse across one of the boundaries, the controller 110 may be configured to control the operation of both of the first and second actuators 102A, 102B to initiate collective or simultaneous adjustment of the positions of the first and second row units 28A, 28B between the operating and raised positions. Additionally, as indicated above, in one embodiment, the seed planting implement 14 includes a single actuator 102 configured to adjust a plurality of row units 28 ganged together along a rockshaft 34. In such embodiment, the controller 110 may be configured to control the operation of the single actuator 102 to initiate collective or simultaneous adjustment the positions of all of the row units 28 ganged together when one of the row units 28 is about to traverse across one of the boundaries. It should be appreciated that, in alternative embodiments, the positions of the first and second row units 28A, 28B may be adjusted between the operating and raised positions as a collective unit when both of the first and second row units 28A, 28B (or a predetermined percentage of the row units 28 when the seed planting implement 14 includes more than two row units 28) are about to traverse across or have traversed across one of the boundaries.

Alternatively, in several embodiments, the positions of the row unit(s) 28 may be adjusted between the operating and raised positions on an individual basis. Specifically, in one embodiment, when the first row unit 28A is about to traverse across one of the boundaries, the controller 110 may be configured to control the operation of the first actuator 102A to initiate adjustment of the position of the first row unit 28A between the operating and raised positions. Similarly, when the second row unit 28B is about to traverse across one of the boundaries, the controller 110 may be configured to control the operation of the second actuator 102B to initiate adjustment of the position of the second row unit 28B between the operating and raised positions. As such, the controller 110 may be configured to control the operation of the first and second actuators 102A, 102B such that the position of the first row unit 28A is adjusted without also adjusting the position of the second row unit 28B and/or the position of the second row unit 28B is adjusted without also adjusting the position of the first row unit 28A.

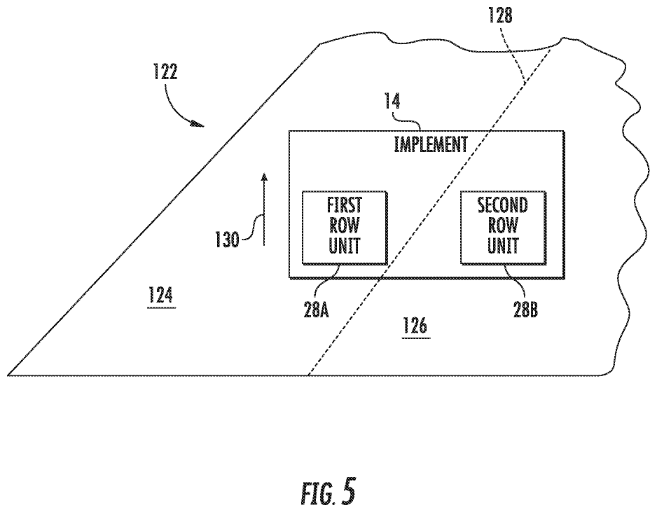

Referring now to FIG. 5, an example map of a portion of a field 122 having a processed portion 124 and an unprocessed portion 126 separated by a boundary (e.g., separated by dashed line 128 in FIG. 5) is illustrated in accordance with aspects of the present subject matter. In certain instances, the first row unit 28A of the seed planting implement 14 may be positioned to traverse across the boundary 128 at a different time than the second row unit 28B of the seed planting implement 14. More specifically, the seed planting implement 14 may be moved across the field 122 along a direction of travel (e.g., as indicated by arrow 130 in FIG. 5). As such, in the instance shown in FIG. 5, the first row unit 28A is positioned within the processed portion 124 of the field 122, while the second row unit 28B is positioned within the unprocessed portion 126 of the field 122. In such instance, the first row unit 28A may be positioned at the raised position such that its disc opener(s) 30 is lifted out of the ground, while the second row unit 28B may be positioned at the operating position such that its disc opener(s) 30 engages the soil. In this regard, when the first row unit 28A is about to traverse across the boundary 128 from the unprocessed portion 126 of the field 122 into the processed portion 124 of the field 122, the controller 110 may be configured to control the operation of the first and second actuators 102A, 102B in a manner that moves the first row unit 28A to the raised position while the second row unit 28B remains the operating position. Thereafter, when the second row unit 28B is about to traverse across the boundary 128 from the unprocessed portion 126 into the processed portion 124, the controller 110 may be configured to control the operation of the first and second actuators 102A, 102B in a manner that moves the second row unit 28B to the raised position while the second row unit 28B remains the raised position. However, it should be appreciated that the position of the first and second row units 28A, 28B may be simultaneously adjusted when both row units 28A, 28B are about to traverse across the boundary 128 at the same time

As indicated above, the controller 110 may be configured to control the operation of one or more actuators 102 to initiate adjustment of the positions of the associated row unit(s) 28 between the operating and raised positions when it is determined that such row unit(s) 28 is about to traverse across one of the boundaries. Specifically, as shown in FIG. 4, in several embodiments, the controller 110 maybe configured to control the operation of the actuators 102A, 102B by actively controlling the operation of associated valves 134, 136, such as pressure regulating valves (PRVs), of the seed planting implement 14, thereby allowing the controller 110 to actively initiate adjustment of the positions of the first and/or second row units 28A, 28B. For example, in the illustrated embodiment, the controller 110 may be communicatively coupled to the first and second valves 132, 134 to allow control signals (e.g., indicated by dashed lines 136 in FIG. 4) to be transmitted from the controller 110 to the first and second valves 132, 134. In this regard, the controller 110 may be configured to control the operation of the first and second valves 132, 134 in a manner that regulates the pressure of the hydraulic fluid supplied to the associated actuator 102A, 102B from a reservoir 138 of the seed planting implement 14.

In one embodiment, the controller 110 may be configured to control the operation of the first valve 132 such that the fluid pressure supplied to the first actuator 102A is decreased when it is determined that the first row unit 28A is about to traverse across one of the boundaries into one of the processed portions of the field. Similarly, the controller 110 may be configured to control the operation of the second valve 134 such that the fluid pressure supplied to the second actuator 102B is decreased when it is determined that the second row unit 28B is about to traverse across one of the boundaries into one of the processed portions of the field. Decreasing the fluid pressure within the first and second actuators 102A, 102B may move the corresponding row unit 28A, 28B from the operating position to the raised position. Conversely, the controller 110 may be configured to control the operation of the first valve 132 such that the fluid pressure supplied to the first actuator 102A is increased when it is determined that the first row unit 28A is about to traverse across one of the boundaries into one of the unprocessed portions of the field. Similarly, the controller 110 may be configured to control the operation of the second valve 134 such that the fluid pressure supplied to the second actuator 102B is increased when it is determined that the second row unit 28B is about to traverse across one of the boundaries into one of the unprocessed portions of the field. Increasing the fluid pressure within the first and second actuators 102A, 102B may move the corresponding row unit 28A, 28B from the raised position to the operating position.

Referring now to FIG. 6, a flow diagram of one embodiment of a method 200 for controlling the position of row units of an agricultural implement is illustrated in accordance with aspects of the present subject matter. In general, the method 200 will be described herein with reference to the seed planting implement 14 and the system 100 described above with reference to FIGS. 1-5. However, it should be appreciated by those of ordinary skill in the art that the disclosed method 200 may generally be utilized to control the position of row units for any agricultural implement having any suitable implement configuration and/or in connection with any system having any suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include operating, with a computing device, an implement such that the implement is moved across a field. For instance, as described above, a controller 110 may be configured to control the operation of one or more components of a work vehicle 10, an air cart 12, and/or a seed planting implement 14 such that the implement 14 is moved across the field.

Additionally, at (204), the method 200 may include monitoring, with the computing device, the current location of a row unit of the implement relative to a boundary defined between a processed portion of the field and an unprocessed portion of the field. For instance, as described above, the controller 110 may be configured to monitor the current location of a row unit 28 of the seed planting implement 14 relative to one or more boundaries defined between one or more processed portions of the field and one or more unprocessed portions of the field based on one or more received inputs. Such inputs may include location data 118 received from a location sensor 108 and/or user feedback signals 120 received from a user interface 116.

Moreover, as shown in FIG. 6, at (206), the method 200 may include, when the row unit is about to traverse across the boundary, controlling, with the computing device, the operation of an actuator of the implement to initiate adjustment of the position of the row unit between an operating position relative to the ground and a raised position relative to the ground. For instance, as described above, when the row unit 28 is about to traverse across the boundary, the controller 110 may be configured to transmit control signals 136 to an actuator 102 instructing the actuator 102 to initiate adjustment of the position of the row unit 28 between the operating and raised position.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for controlling the position of row units of an agricultural implement as the implement is moved across a field, the system comprising:
a row unit;
an actuator configured to adjust a position of the row unit between an operating position relative to the ground and a raised position relative to the ground; and
a controller configured to monitor a current location of the row unit relative to a boundary defined between a processed portion of the field and an unprocessed portion of the field, the controller being further configured to control an operation of the actuator to initiate adjustment the position of the row unit between the operating and raised positions when it is determined that the row unit is about to traverse across the boundary.

2. The system of claim 1, wherein the controller is configured to control the operation of the actuator to initiate adjustment the row unit from the operating position to the raised position when it is determined that the row unit is about to traverse across the boundary into the processed portion of the field.

3. The system of claim 1, wherein the controller is configured to control the operation of the actuator to initiate adjustment the row unit from the raised position to the operating position when it is determined that the row unit is about to traverse across the boundary into the unprocessed portion of the field.

4. The system of claim 1, wherein the row unit corresponds to a first row unit, the system further comprising:
a second a row unit, the actuator being configured to adjust a position of the second row unit between the operating and raised positions, the controller being further configured to control an operation of the actuator to initiate collective adjustment the positions of the first and second row units between the operating and raised positions when it is determined that the first and second row units are about to traverse across the boundary.

5. The system of claim 1, wherein the row unit corresponds to a first row unit and the actuator corresponds to a first actuator, the system further comprising:
a second row unit; and
a second actuator configured to adjust a position of the second row unit between the operating and raised positions.

6. The system of claim 5, wherein the controller is further configured to control the operation of the first and second actuators to initiate collective adjustment the positions of the first and second row units between the operating and raised positions when it is determined that the first and second row units are about to traverse across the boundary.

7. The system of claim 5, wherein the controller is configured to monitor current locations of the first and second row units relative to the boundary, the controller being further configured to independently control the operation of the first and second actuators such that adjustment of the first row unit between the operating and raised positions is initiated when it is determined that the first row unit is about to traverse across the boundary and adjustment of the second row unit between the operating and raised positions is initiated when it is determined that the second row unit is about to traverse across the boundary.

8. The system of claim 7, wherein the first row unit is positioned relative to the boundary such that the first row unit traverses across the boundary at a different time than the second row unit, the first row unit being moved between the operating and raised positions prior to or before the second row unit is moved between the operating and raised positions.

9. The system of claim 1, further comprising:
a sensor configured detect a parameter indicative of the location of the row unit, the sensor being communicatively coupled to the controller, wherein the controller is further configured to monitor the current location of the row unit based on data received from the sensor.

10. The system of claim 1, wherein the implement comprises a seed planting implement.

11. An agricultural implement, comprising:
a toolbar;
a first row unit adjustably mounted on the toolbar, the first row unit including a first furrow forming device;
a first actuator configured to adjust a position of the first row unit relative to the toolbar to move the first row unit between an operating position relative to the ground and a raised position relative to the ground;
a second row unit adjustably mounted on the toolbar, the second row unit including a second furrow forming device;
a second actuator configured to adjust a position of the second row unit relative to the toolbar to move the second row unit between the operating and raised positions; and
a controller configured to monitor current locations of the first and second row units relative to a boundary defined between a processed portion of a field and an unprocessed portion of the field, the controller being further configured to independently control the operation of the first and second actuators such that adjustment of the first row unit between the operating and raised positions is initiated when it is determined that the first row unit is about to traverse across the boundary and adjustment of the second row unit device between the operating and raised positions is initiated when it is determined that the second row unit is about to traverse across the boundary.

12. A method for controlling the position of row units of an agricultural implement, the implement including an actuator configured to adjust the row unit between an operating position relative to the ground and a raised position relative to the ground, the method comprising:
operating, with a computing device, the implement such that the implement is moved across a field;
monitoring, with the computing device, a current location of the row unit relative to a boundary defined between a processed portion of the field and an unprocessed portion of the field; and
when the row unit is about to traverse across the boundary, controlling, with the computing device, an operation of the actuator to initiate adjustment the position of the row unit between the operating and raised positions.

13. The method of claim 12, further comprising:
when the row unit is about to traverse across the boundary into the processed portion of the field, controlling, with the computing device, the operation of the actuator to initiate adjustment the position of the row unit between from the operating position to the raised position.

14. The method of claim 12, further comprising:
when the row unit is about to traverse across the boundary into the unprocessed portion of the field, controlling, with the computing device, the operation of the actuator to initiate adjustment the position of the row unit between from the raised position to the operating position.

15. The method of claim 12, wherein the row unit corresponds to a first row unit, the implement further comprising a second row unit, the actuator being configured to initiate adjustment the second row unit between the operating and raised positions, the method further comprising:
when the first and second row units are about to traverse across the boundary, controlling, with the computing device, the operation of the actuator to initiate collective adjustment the positions of the first and second row units between the operating and raised positions.

16. The method of claim 12, wherein the row unit corresponds to a first row unit and the actuator corresponds to a first actuator, the implement further comprising a second row unit and a second actuator configured to move the second row unit between the operating and raised positions, the method further comprising:
when the first and second row units are about to traverse across the boundary, controlling, with the computing device, the operation of the first and second actuators to initiate collective adjustment the positions of the first and second row units between the operating and raised positions.

17. The method of claim 12, wherein the row unit corresponds to a first row unit and the actuator corresponds to a first actuator, the implement further comprising a second row unit and a second actuator configured to move the second row unit between the operating and raised positions, the method further comprising:
monitoring, with the computing device, current locations of the first and second row units relative to the boundary;
independently controlling, with the computing device, the operation of the first and second actuators such that adjustment of the first row unit between the operating and raised positions is initiated when it is determined that the first row unit is about to traverse across the boundary and adjustment of the second row unit between the operating and raised positions is initiated when it is determined that the second row unit is about to traverse across the boundary.

18. The method of claim 17, wherein the first row unit is positioned relative to the boundary such that the first row unit traverses across the boundary at a different time than the second row unit, the first row unit being moved between the operating and raised positions prior to or before the second row unit is moved between the operating and raised positions.

19. The method of claim 12, wherein monitoring the current location of the row unit comprises monitoring, with the computing device, the current location of the row unit based on data received from a sensor.
